(19) United States
(12) Patent Application Publication
(10) Pub. No.: US 2018/0149730 A1
(43) Pub. Date: May 31, 2018

(54) Cognitive MIMO Radar with Multi-dimensional Hopping Spread Spectrum and Interference-Free Windows for Autonomous Vehicles

(71) Applicants: Wenhua Li, Auburndale, MA (US); Min Xu, Auburndale, MA (US)

(72) Inventors: Wenhua Li, Auburndale, MA (US); Min Xu, Auburndale, MA (US)

(21) Appl. No.: 15/361,382

(22) Filed: Nov. 26, 2016

(51) Int. Cl. G01S 7/02; G01S 13/02; G01S 13/93; G01S 17/93

(52) U.S. Cl. CPC G01S 7/023; G01S 17/936; G01S 13/931; G01S 13/0209

(57) ABSTRACT

This invention is related to a cognitive Multi-Input Multi-Output (MIMO) radio frequency (or laser) radar with large-area synchronized multi-dimensional hopping spread spectrum and Interference-Free Windows (IFWs) for autonomous vehicles comprising of (1) analog component; (2) digital baseband component; (3) multi-dimensional hopping code generator; (4) large-area time synchronization; (5) cooperative IFW; and (6) cognitive engine. The new MIMO radar can provide interference-free environmental perception intelligently by the multi-dimensional IFWs formulated by beat-frequency hopping, beat-time hopping, discrete sequence (DS), cooperative IFW, array processing, and image denoising and fusion, etc. This invention increases the frequency efficiency greatly, and be applied to autonomous vehicles and robotics under sparse, dense, mixed autonomous and human driving, or completely autonomous driving environments.

### TECHNICAL FIELD

This invention relates to a cognitive Multi-Input Multi-Output (MIMO) Radio Frequency (RF) (or laser) radar with large-area synchronized (LAS) multi-dimensional hopping spread spectrum and Interference-Free Windows (IFWs), which can provide inter-radar interference-free environmental perception to enhance the safety of autonomous vehicles.

### BACKGROUND OF THE INVENTION

Autonomous driving is one of the fastest-growing fields in automotive electronics. SAE classifies the autonomous vehicles into 6 levels from Level 0 to Level 5. Level 0 means the automated system has no vehicle control, but may issue warnings. Level 5 means the vehicle is controlled completely by the autopilot without any intervention from human driver.

Autonomous driving is developed to improve the safety and efficiency of vehicle systems. There are mainly three environmental perception approaches to implement autonomous driving: (1) non-cooperative sensor fusion; (2) GPS navigation/vehicle-to-X networks used as cooperative sensors; (3) fusion of non-cooperative and cooperative sensors. More and more vehicles are being equipped with radar systems including Radio Frequency (RF) radar and laser radar (LIDAR) to provide various safety functions such as Adaptive Cruise Control (ACC), Forward Collision Warning (FCW), Automatic Emergency Braking (AEB), Lane Departure Warning (LDW), and self-driving.

Passive vehicle sensors such as cameras cannot work well under harsh environments including fog, rain, and snow. One advantage of active RF radars and LIDAR is that they can work under different environments. Cameras and radars can also detect both non-cooperative and cooperative targets. RF radars can be categorized into Long Range Radar (LRR), Medium Range Radar (MRR), and Short Range Radar (SRR). MIMO automotive radars have been proposed in recent years to improve the range and angle resolution. However, although RF radar is one of the most mature sensors for vehicle safety applications at present, it has a severe shortcoming: inter-radar interference. This interference problem for both RF radar and LIDAR will become more and more severe because eventually every vehicle will be deployed with radars.

At present, commercial vehicle radars only provide limited interference mitigation ability. The interference problem is not severe because most vehicles are not equipped with radars yet. Although some radar interference mitigation algorithms have been proposed in the literature, they solve the problem to some extent, but cannot work well especially under dense traffic, mixed vehicles with and without Internet of Vehicles (IoV), mixed autonomous and human-driving vehicles, and fully self-driving environments. Traditionally, non-overlapping frequency bands and time slots are assigned to different radars in order to avoid interference. However, because of limit of the frequency band and time slot resources, the radar interference may not be avoided completely, especially for high-density traffic scenarios.

This invention proposes a new MIMO radar approach to overcome interference through multi-dimensional hopping spread spectrum and IFWs. All radars are time-synchronized in large areas (LAS). Overlapping or even completely same frequency bands and time slots are assigned to different radars intelligently by the cognitive engine. Multiple MIMO radars may be formulated along different directions such as forward-looking, backward-looking and side-looking. Because the frequency efficiency is increased greatly, radars in a limited area (such as 200 to 300 meters) can work well without interference under dense traffic, mixed autonomous and human driving, mixed vehicles with and without IoV, and completely autonomous driving scenarios.

### SUMMARY

This invention is related to a cognitive MIMO radio frequency (or laser) radar with LAS multi-dimensional hopping spread spectrum and Interference-Free Windows (IFWs) for autonomous vehicles comprising of (1) analog component; (2) digital baseband component; (3) multi-dimensional hopping code generator; (4) large-area time synchronization; (5) cooperative IFW; and (6) cognitive engine.

The present radars installed on different vehicles usually have different clock resources. They are not synchronized to one global reference clock. Large-area time synchronization of vehicle radars is proposed, which is very helpful to increase the frequency efficiency.

Non-overlapping frequency bands and time slots are usually assigned to different radars. Frequency Hopping (FH) and Time Hopping (TH) spread spectrum also hop between non-overlapping frequency bands and time slots. For popular automotive radars such as Frequency-Modulated Continuous Waveform (FMCW), the frequency band after ADC is very narrow. Partially overlapping frequency bands and time slots can be assigned to different time-synchronized radars without generating interference. Besides FH and TH, Discrete Sequence (DS) is another kind of spread spectrum technique. The DS code can also be hopped. Multi-dimensional hopping spread spectrum provides 3D interference-free windows by beat-frequency hopping, beat-time hopping, and DS waveform hopping, in which frequency bands and time slots can be partially overlapped. Triangle and its variations are the most popular waveforms for FMCW radars. New OFDM (Orthogonal Frequency Division Multiplex) waveform was also proposed in recent years for FMCW MIMO radars.

Traditionally, the reflected signals with the same frequency band and time slot from radars on other vehicles are considered as interference and various methods were proposed to mitigate them. However, this invention utilizes these transmitted radar signals from other cooperative vehicles equipped with Internet of Vehicles (IoV) in a different way. Radar signals from other vehicles are used as useful information instead of interference, which formulates the fourth dimension of interference-free windows.

Space Division Multiple Access (SDMA) can provide the fifth dimension of interference-free windows. MIMO beamforming/Space-Time-Waveform Adaptive Processing (STWAP) can cancel the non-cooperative interference signals from different directions.

The sixth dimension of IFWs is based on denoising and image fusion. The output of FFTs in FMCW radar is noisy and may contain multipath interference or interference from other non-cooperative radars. Deep Neural Networks (DNN) denoising can filter the noise and interference effectively. Furthermore, image fusion can also restore the clean image while cancelling the interference from multiple image frames. Image denoising and fusion is proposed to formulate the sixth dimension of IFWs for vehicle radars.

Radar baseband processing can be classified into two categories: model-based and model-free. Model based processing and model-free DNN approaches are used to implement baseband signal processing of MIMO radars. These two methods can be fused to further enhance the radar performance.

This invention can be applied not only to the advanced driver assistance systems of automobiles, but also to the safety systems of self-driving cars, robotics, flying cars, unmanned ground vehicles, and unmanned aerial vehicles.

### BRIEF DESCRIPTION OF THE DRAWINGS

The present invention may be understood, by way of examples, to the following drawings, in which:

FIG. 1 is a top view of the cognitive MIMO radar with LAS multi-dimensional hopping spread spectrum and Interference-Free Windows (IFWs).

FIG. 2 is a block diagram showing chaotic code design for multi-dimensional hopping spread spectrum.

FIG. 3 illustrates the first chaotic sequence for generating FH code.

FIG. 4 shows the FH code based on the first chaotic sequence.

FIG. 5 shows the second chaotic sequence.

FIG. 6 shows the TH code based on the second chaotic sequence.

FIG. 7 shows the third chaotic sequence.

FIG. 8 shows the DS code based on the third chaotic sequence.

FIG. 9A and FIG. 9B illustrate the IFW with Frequency Division Multiple Access (FDMA) and beat-frequency hopping.

FIG. 10A and FIG. 1013 illustrate the IFW with Time Division Multiple Access (TDMA) and beat-time hopping.

FIG. 11 illustrates the IFW with DS waveform hopping.

FIG. 12 illustrates 3D hopping spread spectrum including time, frequency and DS waveform.

FIG. 13 illustrates large-area time synchronization for all radars.

FIG. 14 illustrates the cooperative IFW with Internet of Vehicles (Iov).

FIG. 15 shows the IFW with beamforming/space time waveform adaptive processing (STWAP).

FIG. 16 illustrates the IFW with deep learning networks based denoising and multiple ramp fusion.

FIG. 17 shows the block diagram of model-based baseband MIMO radar signal processing.

FIG. 18 illustrates the end-to-end model-free DNN based MIMO radar signal processing.

FIG. 19 illustrates the deep multimodal fusion of RF MIMO radar with other sensors such as camera and LIDAR.

FIG. 20 illustrates the cognitive engine.

### DETAILED DESCRIPTION OF THIS INVENTION

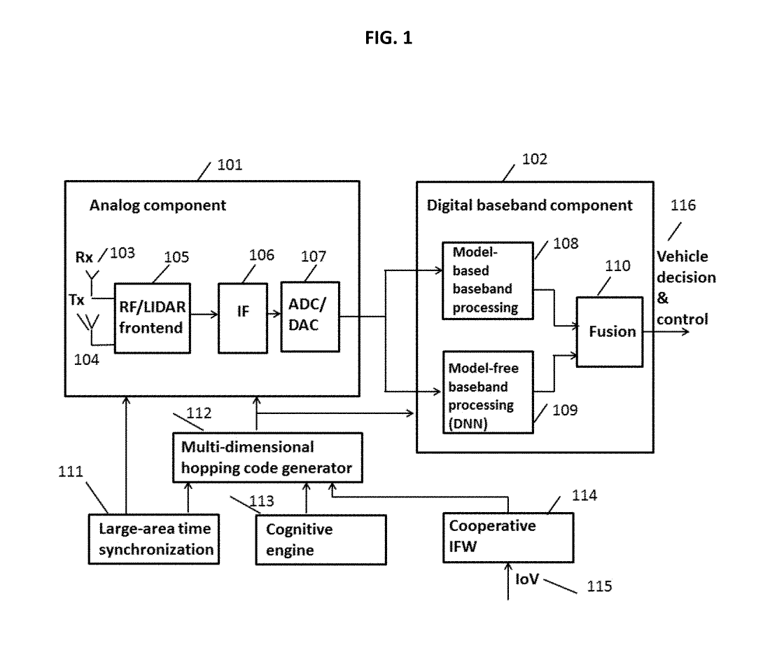

FIG. 1 shows the block diagram of the cognitive MIMO radio frequency (or laser) radar with large-area synchronized multi-dimensional hopping spread spectrum and Interference-Free Windows (IFWs) for autonomous vehicles comprising of (1) analog component 101; (2) digital baseband component 102; (3) multi-dimensional hopping code generator 112; (4) large-area time synchronization 111; (5) cooperative IFW 114; and (6) cognitive engine 113. The analog component 101 has Rx array 103, Tx array 104, RF/LIDAR frontend 105, Intermediate Frequency (IF) 106, and Analog-to-Digital Converter (ADC)/Digital-to-Analog Converter (DAC) 107. Cooperative IFW 114 receives helpful information from IoV 115. The digital baseband component 102 consists of model-based baseband processing 108, model-free baseband processing 109, and fusion 110. The output of fusion 110 will be input into the vehicle decision and control component 116 for autonomous driving. Only one MIMO radar is shown in FIG. 1. Actually there may be a few MIMO radars along different directions such as forward-looking, backward-looking, and side-looking.

The basic flowchart of the cognitive MIMO radar system is explained as follows: The cognitive engine assigns radar parameters (such as frequency bands, time slots, waveform, power level, etc.), and chaotic map parameters. Multi-dimensional chaotic code generator will generate integrated hopping codes for beat-frequency hopping, beat-time hopping, and DS waveform hopping. 3D interference-free windows are formulated by multi-dimensional hopping spread spectrum mainly in the analog domain. The large-area time synchronization provides synchronization of all radars to the global reference clock. Without large-area time synchronization, it is difficult to implement beat-time hopping based IFW. The cognitive engine can assign the same radar parameter set to cooperative vehicles equipped with IoV if not enough different radar parameter sets are available. The digital baseband component implements model-based and/or model-free DNN based processing, which can formulate more dimensions of IFWS in the digital domain.

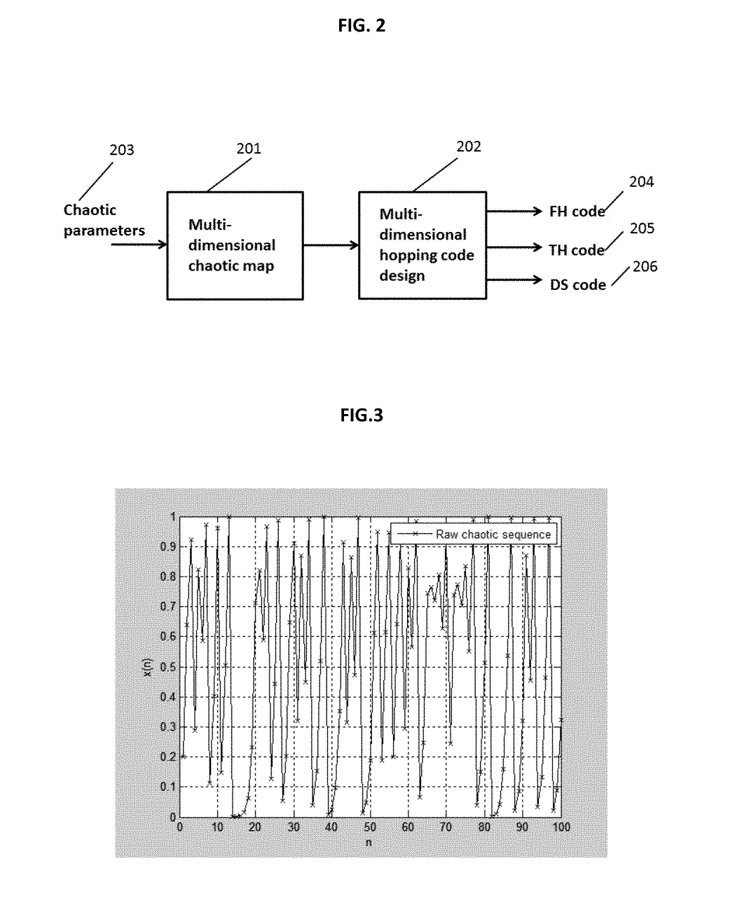

FIG. 2 is a block diagram showing the chaotic code design for multi-dimensional hopping spread spectrum. The multi-dimensional chaotic map 201 will generate multiple chaotic sequences by using the chaotic map parameters 203 assigned by the cognitive engine. Multi-dimensional hopping code design module 202 will generate FH code 204, TH code 205, and DS waveform hopping code 206. Other spread spectrum codes can also be applied to this invention. The advantage of chaotic codes is excellent randomness and huge code number with good correlation properties.

FIG. 3 illustrates one example of chaotic sequence for FH code design. The chaotic sequence is uniformly distributed between (0, 1).

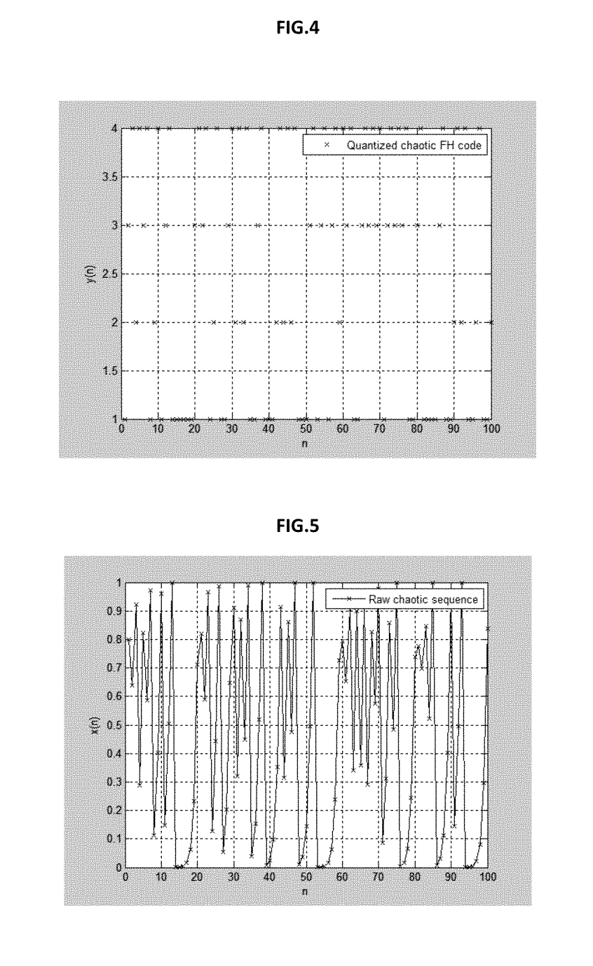

FIG. 4 shows one example of the FH code based on the first chaotic sequence. We can apply various methods to convert a chaotic sequence into a FH code. In FIG. 4, the (0, 1) interval is equally divided into 4 sub-intervals. Each interval represents one frequency band. Then the chaotic FH code y(n) is generated.

FIG. 5 shows the second chaotic sequence. The chaotic sequence is uniformly distributed between (0, 1).

FIG. 6 shows one example of the TH code based on the second chaotic sequence. Various methods can be applied to convert a chaotic sequence into a TH code such as quantization. In FIG. 6, the (0, 1) interval is equally divided into 4 sub-intervals. Each interval represents one time slot. Then the chaotic TH code y(n) is generated.

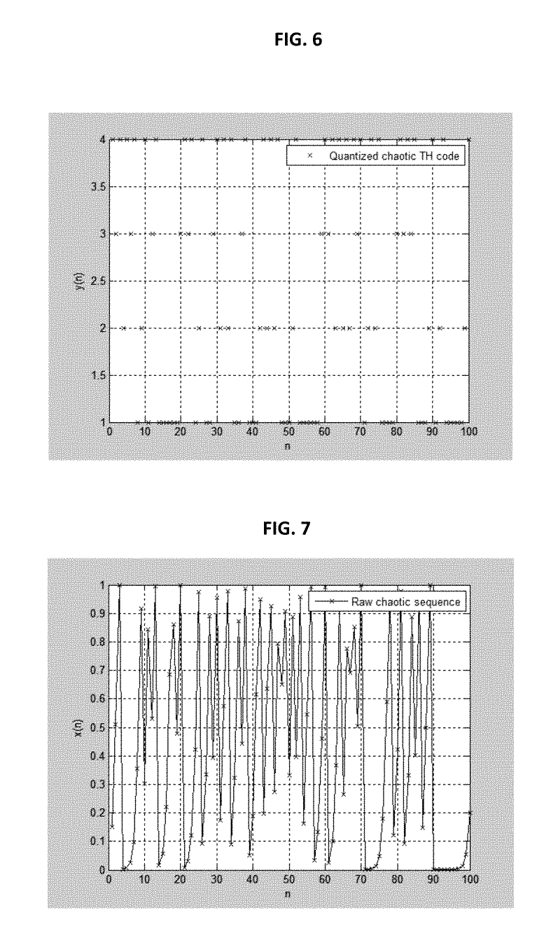

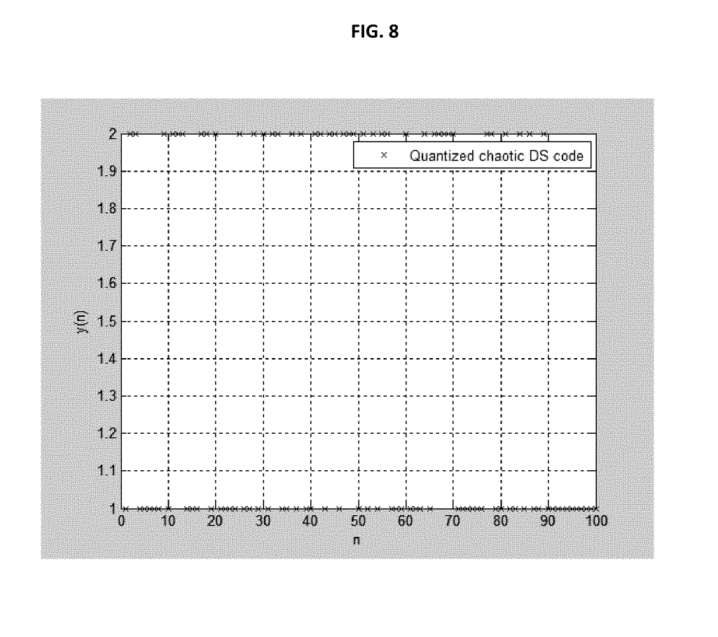

FIG. 7 shows the third chaotic sequence. The chaotic sequence is uniformly distributed between (0, 1).

FIG. 8 shows the DS code based on the third chaotic sequence. Various methods can be applied to convert a chaotic sequence into a DS code {1, 2}. In FIG. 8, the (0, 1) interval is equally divided into 2 sub-intervals. Each interval represents 1/or 2. Then the chaotic DS code y(n) is generated.

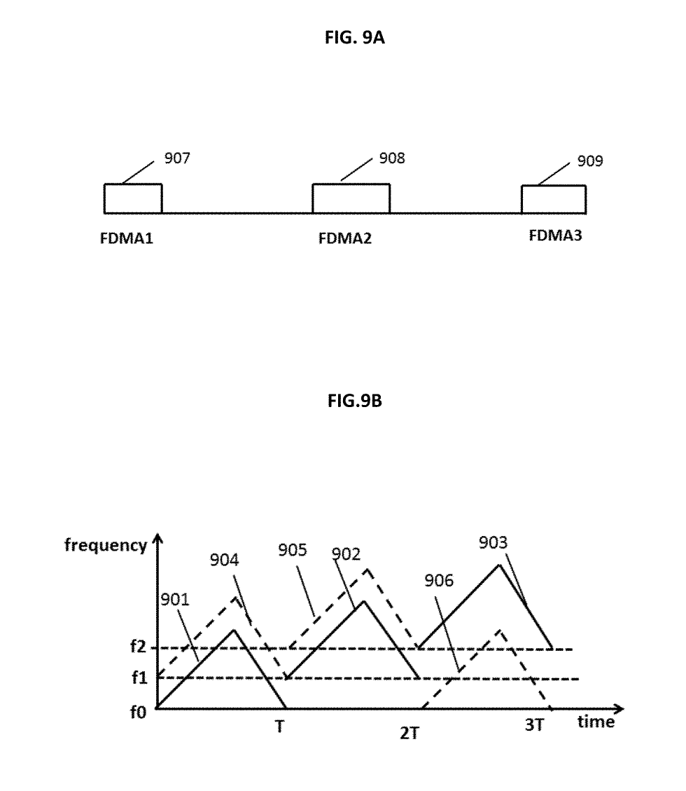

FIG. 9A and FIG. 9B illustrate the IFW with FDMA and beat-frequency hopping. FIG. 9A shows three frequency bands assigned to autonomous vehicles such as 24 GHz (FDMA1 907), 77 GHz (FDMA2 908), and 100 GHz (FDMA3 909). In FIG. 9B, the beat frequency of the first radar is hopping between f0, f1, and f2 during the first three triangle ramps 901, 902, 903 while the beat frequency of the second radar is hopping between f1, f2, and f0 during the first three triangle ramps 904, 905, 906. The frequency hopping bands are partially overlapped. Because the baseband of FMCW radar is narrow, frequency-band filtering can formulate IFW for two radars although hopping frequency bands are partially overlapped.

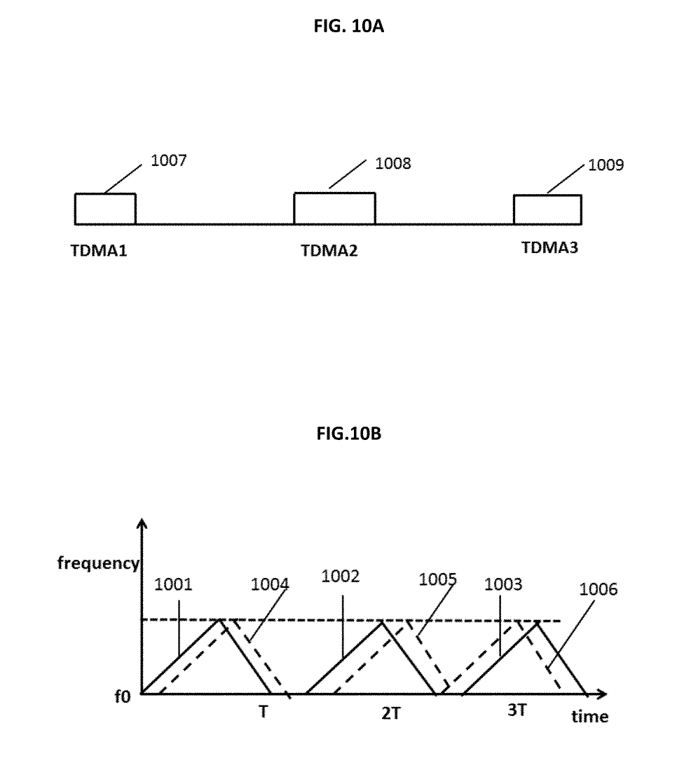

FIG. 10A and FIG. 1013 illustrate the IFW with TDMA and beat-time hopping. FIG. 10A shows cycle deputy (TDMA1 1007, TDMA2 1008, TDMA3 1009) of vehicle radars which can be considered as conventional TDMA. In FIG. 10B, the beat time of the first radar is hopping between 1001, 1002, and 1003 during the first three triangle ramps while the time frequency of the second radar is hopping between 1004, 1005, and 1006 during the first three triangle ramps. The time hopping slots are partially overlapped. Because the baseband of FMCW radar is narrow, frequency-band filtering can formulate IFW for two radars although hopping time slots are partially overlapped.

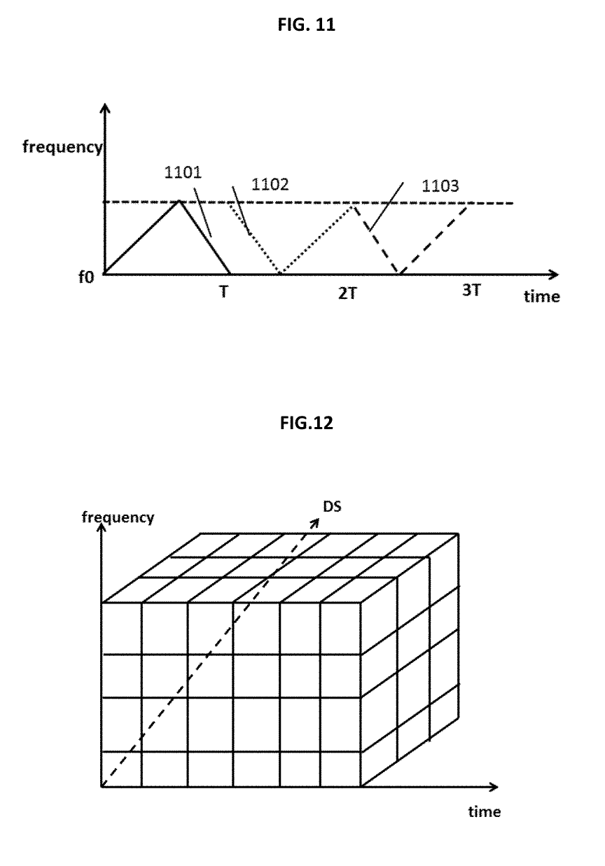

FIG. 11 shows IFW with orthogonal waveform hopping based on DS code. If the DS code is 1, the upward triangle radar waveform is used 1101. If the DS code is 2, downward waveform is used 1102, 1103. Multiple ramp estimation will be fused to obtain the final estimates.

FIG. 12 shows 3D hopping spread spectrum by integrated beat-frequency hopping, beat-time slots hopping, and DS waveform hopping. If the numbers of interference-free beat-frequency bands, beat-time slots, and DS codes are N(f), N(t), and N(d), respectively. Then the number of interference-free cubic for interference-free hopping is N(f)*N(t)*N(d), which is much larger than 1-dimensional case. The cognitive engine will assign multiple time-frequency-DS codes to the same MIMO radar.

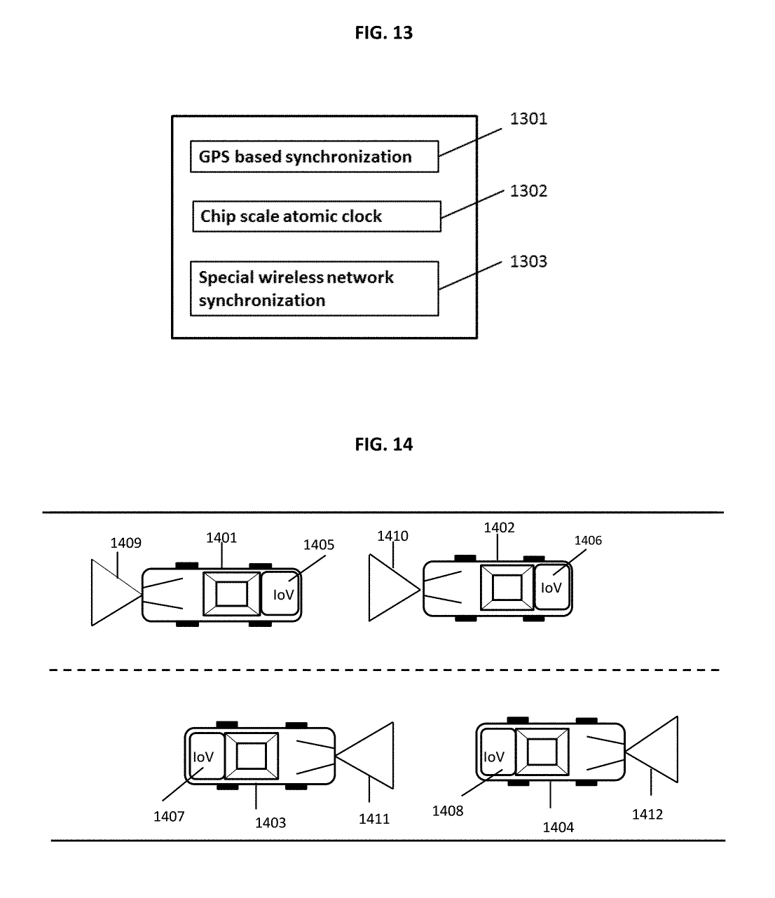

FIG. 13 illustrates large-area time synchronization for all radars. The synchronization methods are GPS based 1301, chip scale atomic clock 1302, and special wireless synchronization 1303.

FIG. 14 illustrates cooperative IFW. Autonomous vehicles equipped with IoV will share their information between vehicles in a designed area. These cooperative vehicles can use the same radar parameter set without interference. In FIG. 14, there are 4 cooperative vehicles 1401, 1402, 1403, 1404. These vehicles are equipped with IoV 1405, 1406, 1407, 1408. The 4 radars 1409, 1410, 1411, 1412 on different cooperative vehicles have no interference although they all use the same radar parameters.

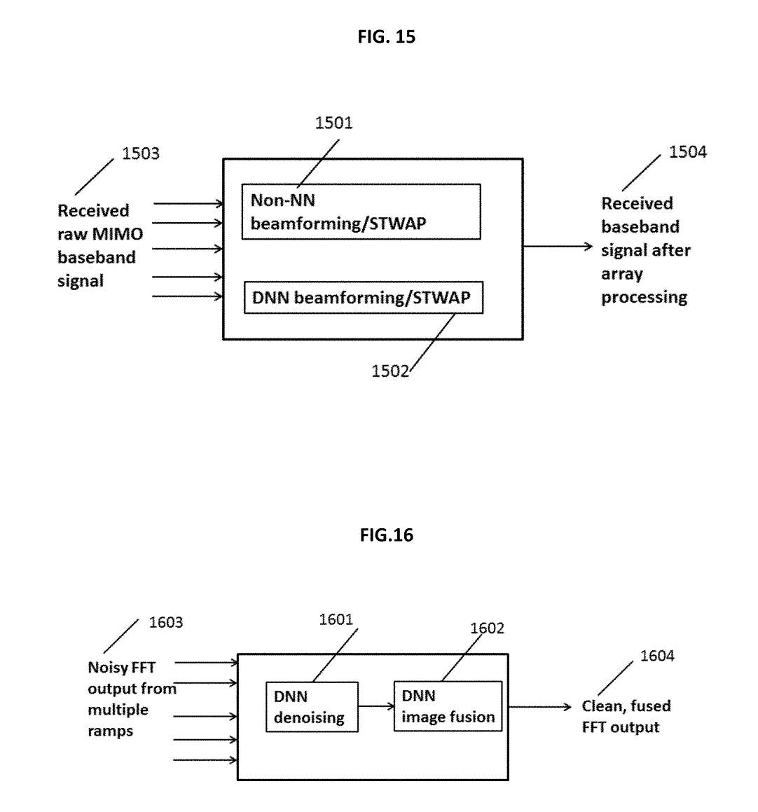

FIG. 15 illustrates IFW with beamforming/STWAP. This dimension of IFWs is formulated by array signal processing. It can be implemented by non-NN based beamforming/STWAP 1501 or DNN based beamforming/STWAP 1502, whose input is received raw MIMO baseband signal 1503 and output is received baseband signal after array processing 1504. This is a spatial multiple access approach.

FIG. 16 illustrates the sixth-dimensional IFW by utilizing denoising and image fusion. The noisy output of FFTs can be processed as images. DNN denoising 1601 and DNN image fusion 1602 can filter noise and interference by machine learning algorithms. Various DNN models can implement this IFW such as autoencoder, Convolutional Neural Network (CNN), Deep Boltzmann Machine (DBM), Recurrent NN (RNN), combined models, etc. The input of DNN denoising 1601 and DNN image fusion 1602 is noisy FFT output from multiple ramps 1603 while its output is clean, fused FFT output 1604.

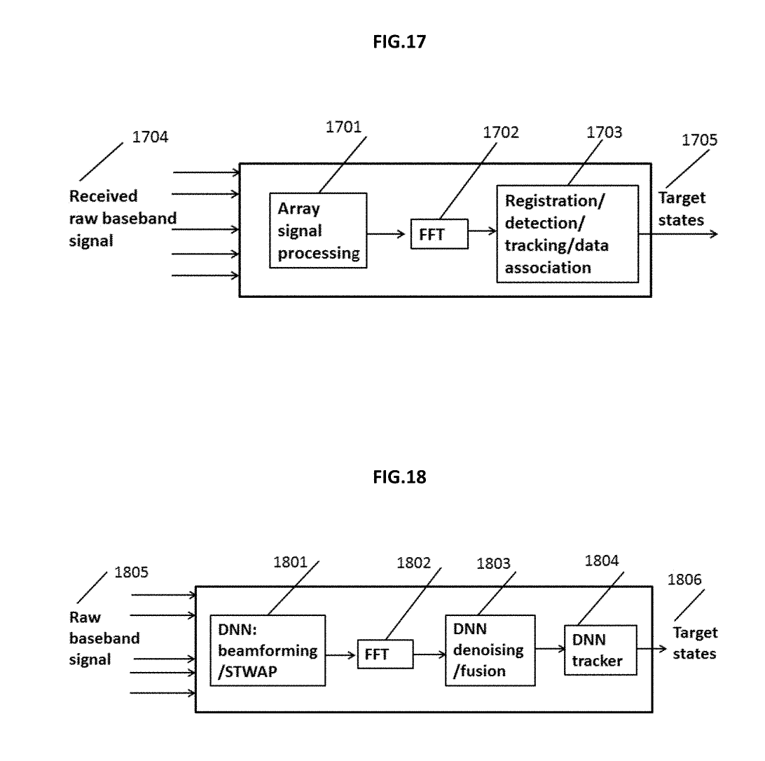

FIG. 17 shows traditional model based baseband MIMO radar processing including array signal processing 1701, FFT 1702, registration/detection/tracking/data association 1703. Traditional radar signal processing is based on models, and does not need big data for training. The input of traditional model based radar signal processing is received raw baseband signal 1704 while its output is estimated target states 1705.

FIG. 18 illustrates end-to-end model-free DNN based MIMO radar signal processing including DNN beamforming/STWAP 1801, FFT 1802, DNN denoising/fusion 1803, and DNN tracker 1804. The input to the DNN baseband processor is the raw baseband signal 1805 and its output is the target states 1806. DNN radar signal processing is model-free, and needs big data for training.

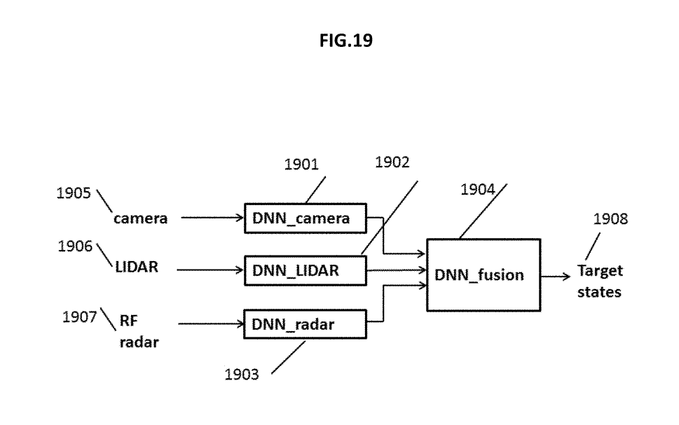

FIG. 19 shows deep multimodal fusion of RF MIMO radar 1907 and other sensors such as cameras 1905 and LIDAR 1906. Multi-modal tracking estimates the target states 1908 by DNN_camera 1901, DNN_LIDAR 1902, DNN_radar 1903, and multimodal fusion module DNN_fusion 1904. The deep multimodal fusion approach consists of low feature-level, intermediate feature-level, and decision-level.

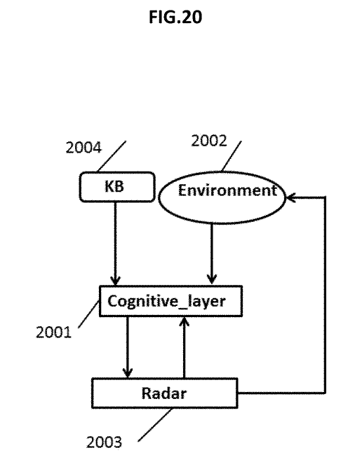

FIG. 20 illustrates the cognitive engine. The cognitive layer 2001 accepts external Knowledge Database (KB) 2004 and environmental information 2002. It controls the radar parameters intelligently 2003.

What is claimed:

1. A cognitive MIMO radio frequency (or laser) radar with large-area synchronized multi-dimensional hopping spread spectrum and Interference-Free Windows (IFWs) for autonomous vehicles comprising of:
analog component;
digital baseband component;
multi-dimensional hopping code generator;
large-area time synchronization;
cooperative IFW;
cognitive engine.

2. A cognitive MIMO radio frequency (or laser) radar as in claim 1, wherein the digital baseband component consists of model-based baseband processing, model-free DNN baseband processing, and fusion module.

3. A cognitive MIMO radio frequency (or laser) radar as in claim 1, wherein the analog component consists of large-area synchronized multiple transmitter antennas/multiple receiver antennas, RF or LIDAR frontend, IF, and ADC/DAC.

4. A cognitive MIMO radio frequency (or laser) radar as in claim 1, wherein the multi-dimensional hopping code generator has the following characteristics:
generating multiple chaotic sequences by using the chaotic map parameters assigned by the cognitive engine;
generating FH code;
generating TH code;
generating DS code;
generating multi-dimensional no-chaotic spread spectrum codes;
formulating 3D interference-free windows.

5. A cognitive MIMO radio frequency (or laser) radar as in claim 1, wherein the large-area time synchronization module consists of GPS based synchronization, chip scale atomic clock, and/or special wireless network time synchronization.

6. A cognitive MIMO radio frequency (or laser) radar as in claim 1, wherein the large-area time synchronization module makes all vehicle radars in large areas be synchronized to the global reference clock.

7. A cognitive MIMO radio frequency (or laser) radar as in claim 1, wherein the cooperative IFW module having the following characteristics:
providing the fourth-dimension IFW although these radars have the same parameters such as frequency band, time slot;
sharing vehicle states and other information through IoV to formulate cooperative sensors.

8. A cognitive MIMO radio frequency (or laser) radar as in claim 1, wherein the cognitive engine has the following characteristics:
accepting external knowledge database and environmental information;
accepting internal states from radars;
controlling the radar parameters intelligently;
assigning the same radar parameter set to cooperative radars if enough different resources are not available;
assigning different radar parameter sets to non-cooperative radars;
assigning multiple radar parameter sets to the same MIMO radar.

9. A cognitive MIMO radio frequency (or laser) radar as in claim 2, wherein model-based baseband signal processing consists of matched filter, detection, range-doppler processing, angle estimation, association, registration, and radar tracking.

10. A cognitive MIMO radio frequency (or laser) radar as in claim 2, wherein model-free baseband processing provides end-to-end Deep Neural Networks (DNN) based MIMO radar signal processing including DNN beamforming/Space-Time-Waveform Adaptive Processing, FFT, DNN denoising, DNN image fusion, and DNN tracker.

11. A cognitive MIMO radio frequency (or laser) radar as in claim 2, wherein model-free and model-based beamforming/STWAP provides the fifth-dimension IFW.

12. A cognitive MIMO radio frequency (or laser) radar as in claim 2, wherein model-free DNN denoising and fusion provides the sixth-dimension IFW.

13. A cognitive MIMO radio frequency (or laser) radar as in claim 2, wherein model-based and model-free DNN baseband processing can be intelligently fused in feature-level or decision-level.

14. A cognitive MIMO radio frequency (or laser) radar as in claim 2, wherein model-free RF radar baseband processing can be fused with other sensors such as cameras and LIDARs.

15. A cognitive MIMO radio frequency (or laser) radar as in claim 2, wherein the digital processing can provide more dimension of IFWs such as power control, blind source separation, OFDM waveforms.

16. A cognitive MIMO radio frequency (or laser) radar as in claim 1, wherein the cognitive MIMO radar can implement all or part of these multi-dimensional IFWs.

17. A cognitive MIMO radio frequency (or laser) radar as in claim 1, wherein multiple similar cognitive MIMO radars (LRR, MRR, SRR) can be implemented along different directions.
